(19) United States
(12) Patent Application Publication
(10) Pub. No.: US 2011/0196878 A1
(43) Pub. Date: Aug. 11, 2011

(54) Friend System Based on Interest Ranking

(76) Inventor: Tsu-Jia WANG, Wugu Township (TW)

(21) Appl. No.: 12/704,176

(22) Filed: Feb. 11, 2010

(51) Int. Cl. G06F 17/30; G06F 15/16; G06F 3/048

(52) U.S. Cl. 707/749; 709/204; 715/733; 707/E17.014; 707/E17.032

(57) ABSTRACT

A friend system based on interest ranking runs in a server. When the user use the personal computer and internet to register as a member of the system, the user can use personal interface, ranking list interface, and the ranking list calculation interface to add or join each ranking item unit, such as “favorite movie ranking list” or “ball team ranking list”. The server stores all related data files in a corresponding database. An operation processor is configured to calculate and generate a personal interest ingredient, and the friend system provides an interaction unit being configured to promote interactions among the users. The personal interface comprises the personal interfaces of the user and the user's friend. A connecting unit is configured to transversely connect and vertically integrate the aforementioned personal interface, the ranking list interface, and the ranking item unit.

### BACKGROUND OF THE INVENTION

1. Field of the Invention

The present invention relates to a friend system based on interest ranking. More particularly, the present invention relates to a friend system utilizing a personal interface, a ranking list interface, or a ranking list calculation interface to make each user add or join interesting ranking list, in which users can interact mutually via an interaction unit.

2. Description of the Prior Art

As the Digital Age coming, people nowadays are used to make friends via internet and chat over internet. Presently, popular internet friend platforms are Blog-Album, internet society, online game, Bulletin Board System (BBS) or Instant Message Software. Taking Blog-Album and internet society as an example, mostly people who has already known each other would mutually connect or surf other user's Blog-Album. Once he or she is attracted by the contents of album or blog belonging to a particular user, he or she would announce a friending invitation, then they can interact with each other by further knowing the other's interests and look for communication subjects.

Taking online game as an example, mostly people who has already known each other or are familiar with each other would fight together in virtual world. When gaming, they would chat to each other and mostly the contents are related to team works and how to play well in the online game, and not related to individual's personal interests.

Taking BBS as an example, usually a board is related to a particular subject and the users can only interact by text to share their experiences but unable to provide image/multimedia information. Besides, the user can only know that users using the same board have common and particular interest, and the user is unable to know whether they are also interested in other subjects just like the user. The BBS is not a full-scope interact platform.

Taking Instant Message Software as an example, the user can only join the others as friends by email address or account then chat mutually, and the user is not able to actively know the interests of online-friends for further interaction.

The above proves that the aforementioned prior art is still faulty in many aspects, which is not a well-found design and remains to be improved.

In view of the failings derived from the aforementioned prior art, the inventor of the present invention was inclined to improve it, and finally succeeded in developing the friend system based on interest ranking after years.

### SUMMARY OF THE INVENTION

The primary objective of the present invention is to provide a friend system based on interest ranking by providing a secured identification mechanism to enhance identification of the users and ensure data security.

The further objective of the present invention is to provide a friend system based on interest ranking by providing a personal interface, therefore all users can easily identify each user's profile and interact with each other.

The further objective of the present invention is to provide a friend system based on interest ranking by providing a ranking list interface. Therefore the user can add or join in the ranking list after reviewing the ranking item of the ranking item unit, and the interaction among users can be improved.

The further objective of the present invention is to provide a friend system based on interest ranking by providing a connecting unit being configured to transversely connect the personal interface and the ranking list interface and to vertically integrate all ranking items.

The further objective of the present invention is to provide a friend system based on interest ranking, in which the present invention further comprises an image/multimedia unit, a reviewing unit, an interaction unit, and a search unit to perform variety.

A friend system based on interest ranking can achieve the aforementioned objectives is briefly described as follow. When the user register as a member by connecting to a server via personal computer and internet, the user is able to use the friend system running in the server and operate the personal interface, ranking list interface, and ranking list calculation interface provided by the friend system to add or join each ranking item unit, such as “favorite movie ranking list” or “ball team ranking list”. The server stores all related data files in a member database and a ranking list database, and a operation processor is configured to calculate and generate a personal interest ingredient according to the ranking item unit that the user joins in, relativity and matching score among ranking items of a single user. Then the friend system provides an interaction unit being configured to provide functions of adding friend, joining cheer squad, subscribing, engaging, subscribing RSS or broadcasting among users. The ranking item of the ranking item unit further comprises an image/multimedia unit and a reviewing unit, and the user can upload related images and multimedia data and make reviews thereby. The personal interface comprises the personal interfaces of the user and the user's friend. A connecting unit is configured to transversely connect and vertically integrate the aforementioned personal interface, the ranking list interface, and the ranking item unit.

### BRIEF DESCRIPTION OF THE DRAWINGS

FIG. 1 shows a friend system based on interesting ranking of the present invention;

FIG. 2 shows a friend system based on interesting ranking of the present invention;

FIG. 3 shows an input/output interface module of a friend system based on interesting ranking of the present invention;

FIG. 4 shows functions of a friend system based on interesting ranking of the present invention;

FIG. 5 shows an embodiment of a friend system based on interesting ranking of the present invention;

FIG. 6 shows another embodiment of a friend system based on interesting ranking of the present invention;

FIG. 7A shows a diagram of personal interface of the friend system based on interest ranking of the present invention;

FIG. 7B shows a diagram of ranking list interface of the friend system based on interest ranking of the present invention;

FIG. 7C shows a diagram of ranking list calculation interface of the friend system based on interest ranking of the present invention;

FIG. 7D shows another embodiment of the friend system based on interest ranking of the present invention;

FIG. 7E shows another embodiment of the friend system based on interest ranking of the present invention;

FIG. 7F shows yet another embodiment of the friend system based on interest ranking of the present invention; and

FIG. 7G shows a relativity comparison unit of the friend system based on interest ranking of the present invention.

### DETAILED DESCRIPTION OF THE PREFERRED EMBODIMENT

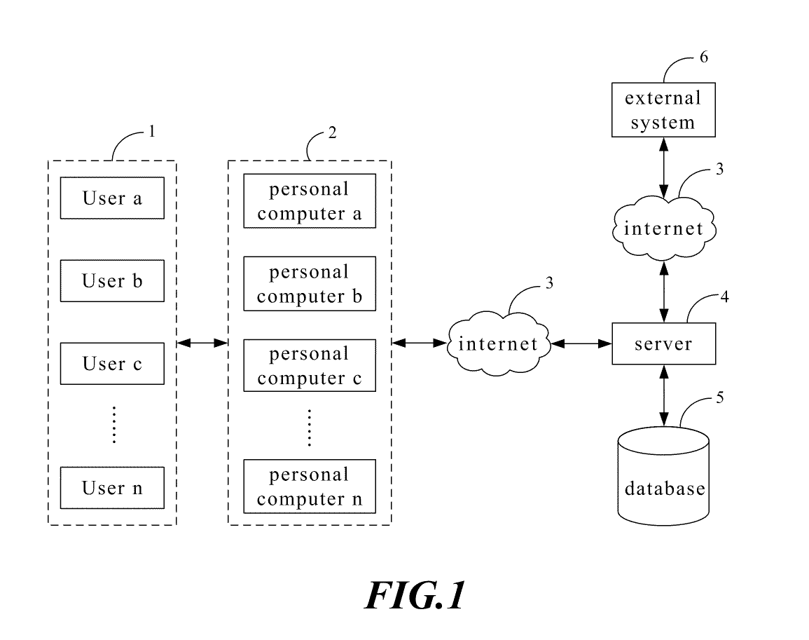

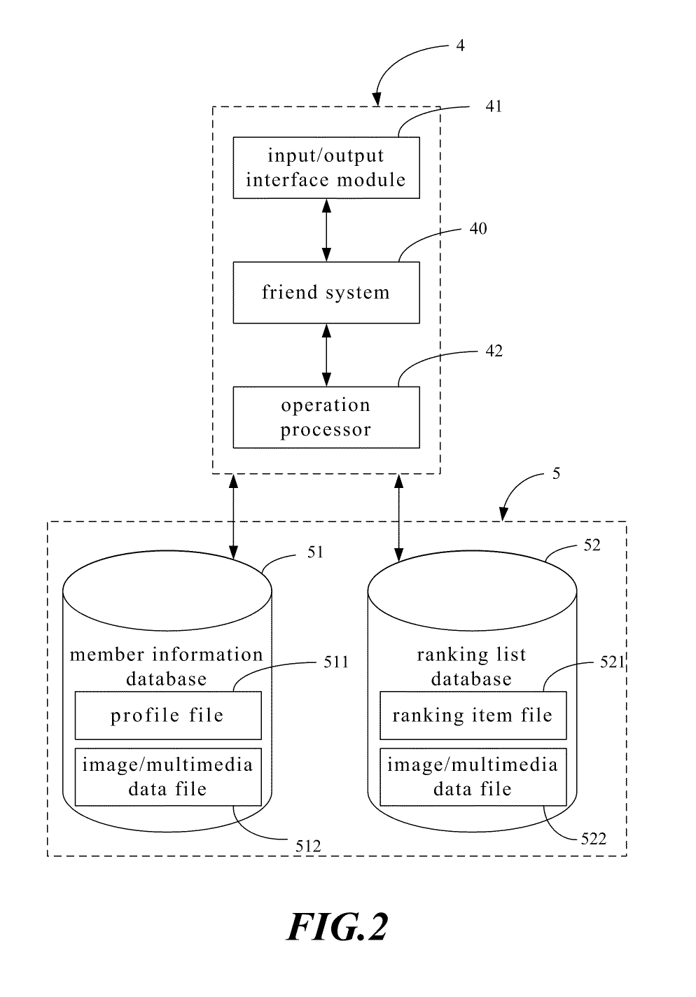

FIGS. 1-4 illustrate a friend system based on interesting ranking of the present invention. Each user 1 is able to use a computer 2 comprising a host and a display to connect to a server 4 via internet 3. The friend system 40 runs inside the server 4 and employs an operation processor 42 to access data of a database 5. The operation result and applications of each unit are transmitted first via an input/output interface module 41 then via the internet 3 to the user 1. The friend system 40 is also able to be connected to an external system 6 via the internet 3. The friend system 40 comprises the follow elements.

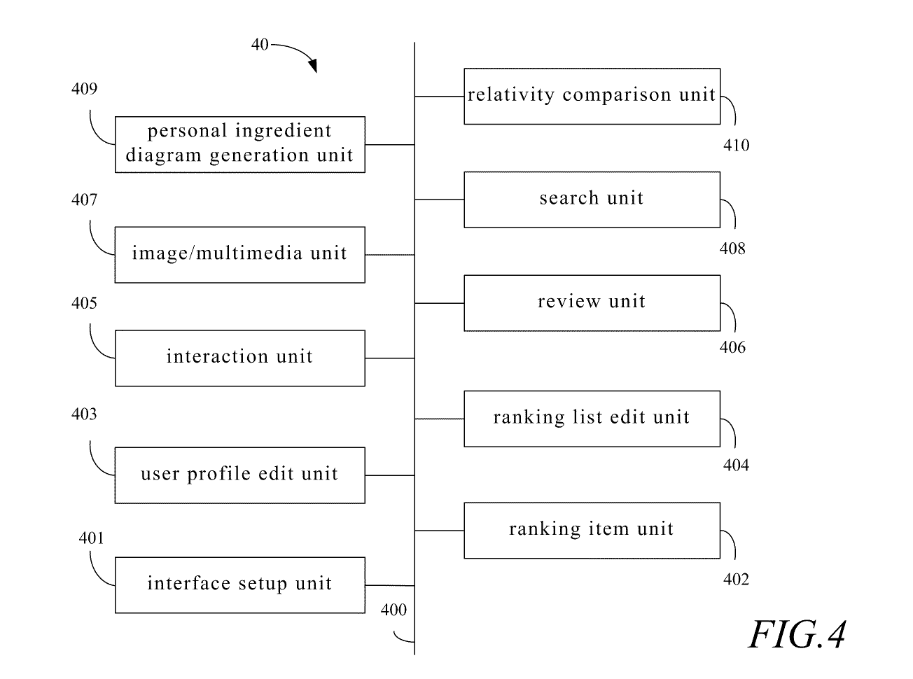

The friend system 40 comprises a connecting unit 400 being configured to connect an interface setup unit 401, a ranking item unit 402, an user profile edit unit 403, a ranking list edit unit 404, an interaction unit 405, a review unit 406, an image/multimedia unit 407, a search unit 408, a personal ingredient diagram generation unit 409 and a relativity comparison unit 410 (as shown in FIG. 4). The connecting unit 400 is configured to transversely connect or vertically integrate these units, such as reviewing the ranking list interface 412 and the ranking list calculation interface 413, or the review unit 406 or the interaction unit 405. Therefore the user 1 is able to make friend with the other user 1 and connect to the person interface 411 of the other user 1.

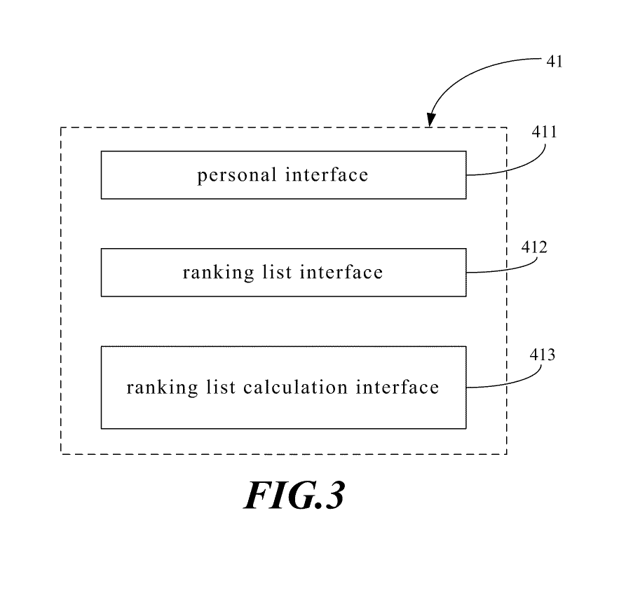

The interface setup unit 401 is configured to receive the desired interface mode selected by the user 1, and then present the user 1 selected personal interface 411, the ranking list interface 412, or the ranking list calculation interface 413 (shown in FIG. 3) and web-site pages in front of the user 1 via the input/output interface module 41 of the server 4. The interface setup unit 401 is configured to store related data into the database 5. The aforementioned interfaces are able to be transversely connected via the connecting unit 400.

The personal interface 411 comprises personal related information of the user 1, such as “my friend list”, “my ranking list”, or “my personal profile”.

The ranking list interface 412 comprises the ranking list composed of the ranking items of the ranking item unit 402.

The ranking list calculation interface 413 is configured to provide calculated hot-popular ranking list and hot-popular ranking item list after vertically connected calculation.

The ranking item unit 402 comprises different ranking item and the combination thereof. For example the ranking item of the favorite movie list may comprises “Ocean's Eleven”, “The Shawshank Redemption”, “Shonen Merikensack”, or “Alien 3”. The user 1 may edit each ranking list via the ranking list edit unit 404 and then edit the ranking of each ranking item. The user 1 may review and response to the reviews of each ranking item via the review unit 406. The user 1 may upload related image/multimedia data of each ranking item to the database 5 via the image/multimedia unit 407.

The user utilize the user profile edit unit 403 for inputting personal profile, such as name, gender, address, marital status, occupation, or email address. The user can also upload personal image to the database 5 via the image/multimedia unit 407.

The user 1 inputs ranking item of the ranking item unit 402 or create a new ranking list via the ranking list edit unit 404.

The user is able to transmit card, add friend, join cheer squad, subscribe, engage, subscribe RSS or broadcast via the interaction unit 405, and store related data in the database 5.

The review unit 406 is configured to review each ranking item of the ranking item unit or the ranking list, and to response to the reviews thereof, and store related data into the database 5.

The image/multimedia unit 407 is configured to upload each ranking item of the ranking item unit 402 or upload the personal image and/or related image/multimedia data of the user profile edit unit 403, and store related data into the database 5.

The user 1 is able to make a keyword search of the ranking list, ranking list item or user profile via the search unit 408, and store related data into the database 5.

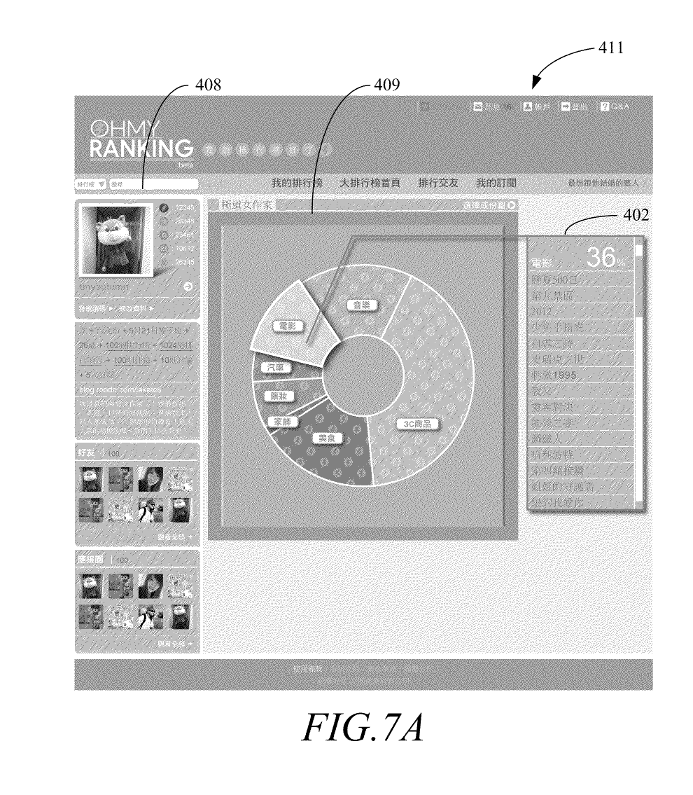

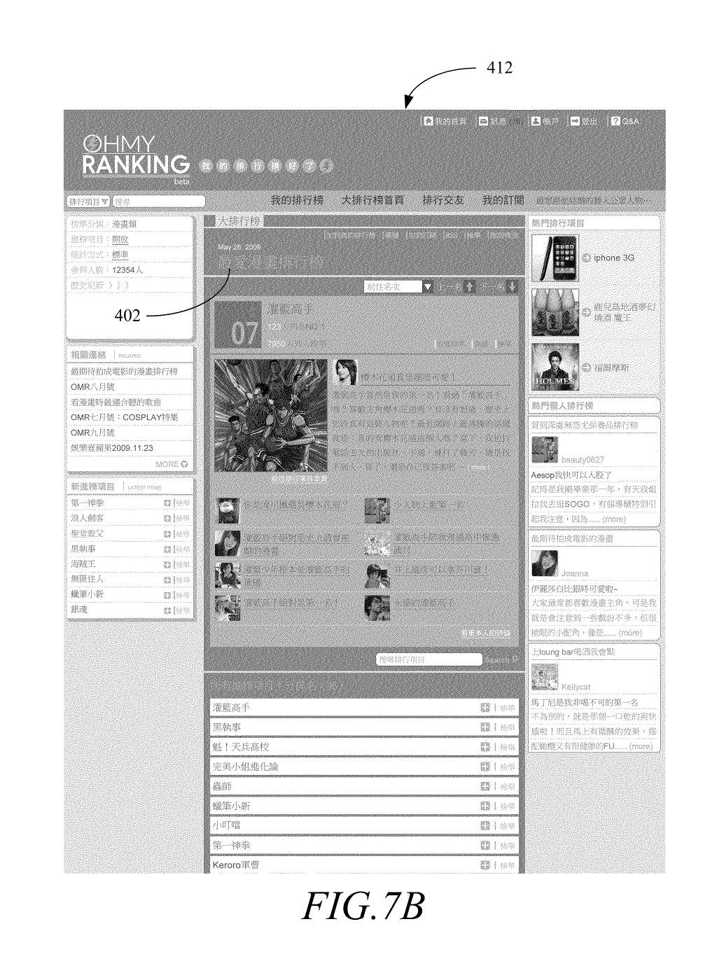

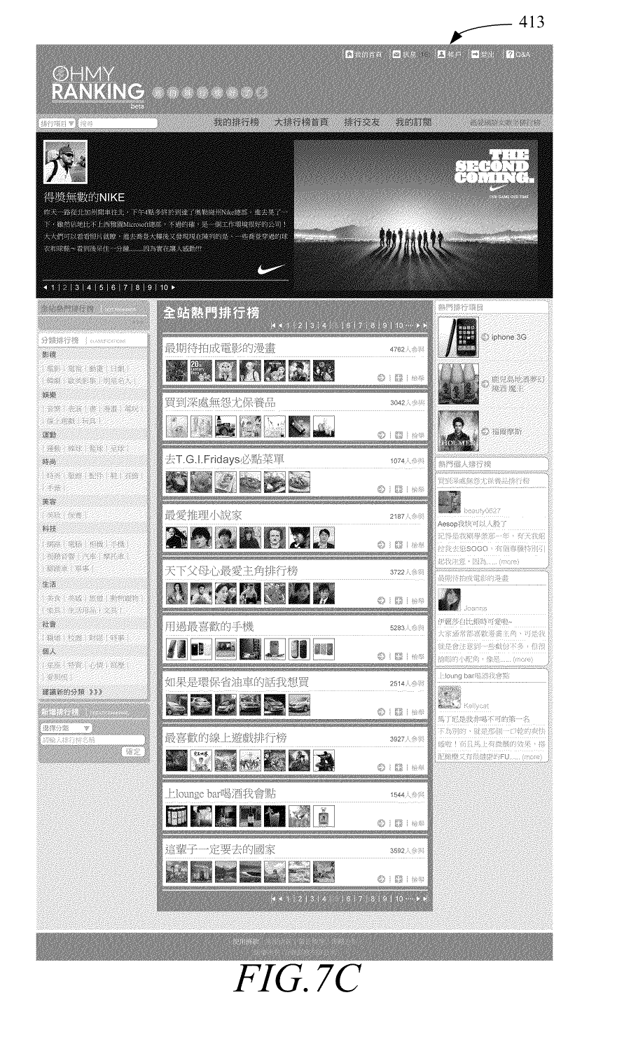

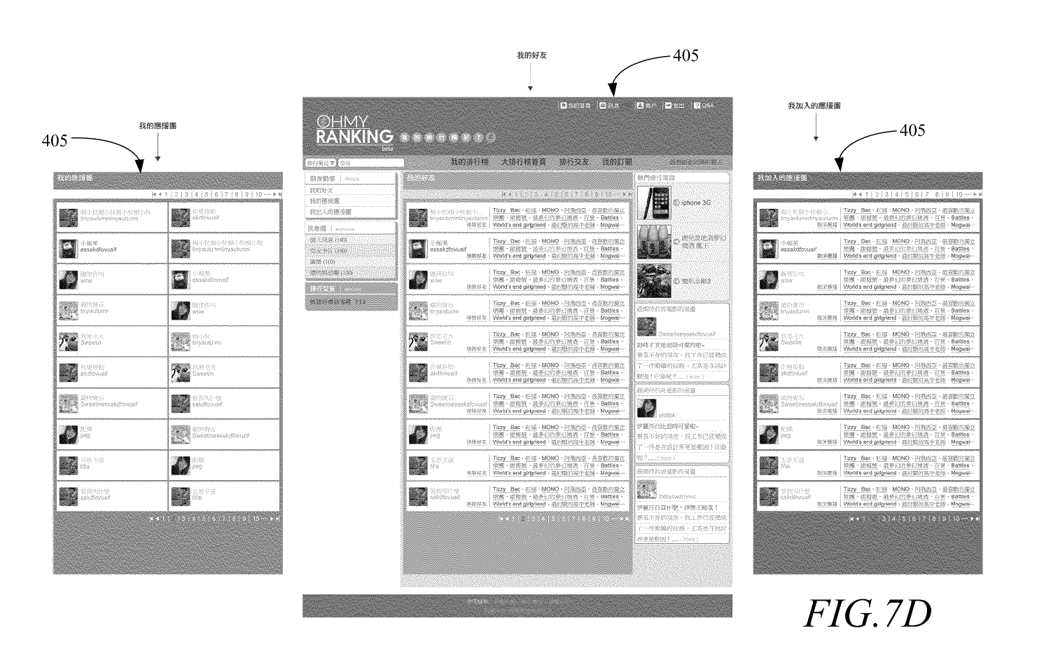

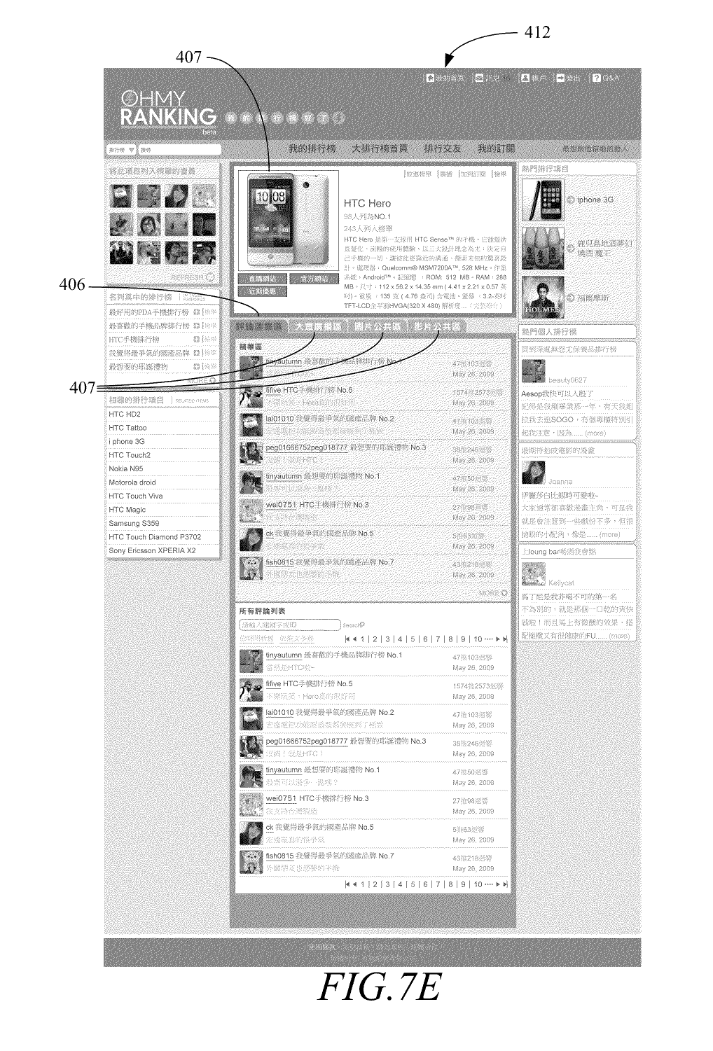

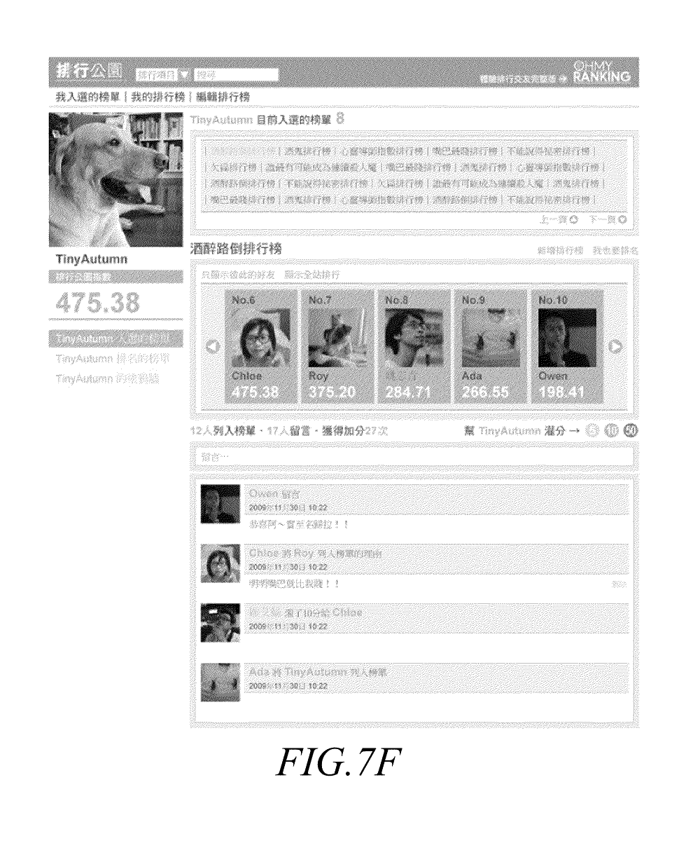

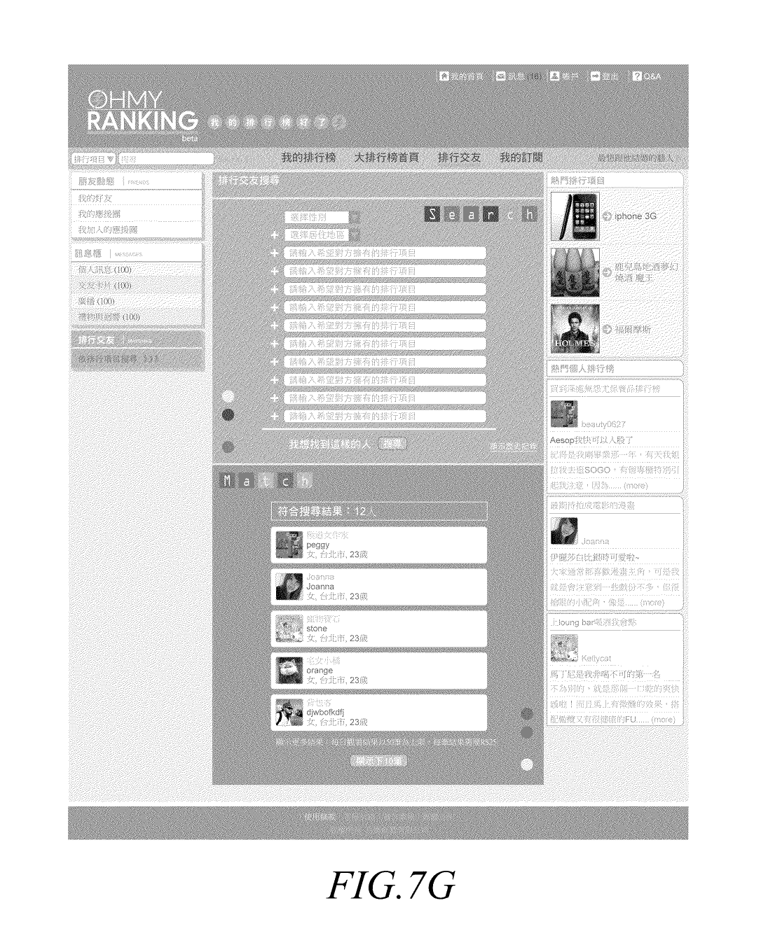

The personal ingredient diagram generation unit 409 is configured to generate a personal ingredient diagram based on the ranking lists of the ranking item unit 402 that the user 1 participating in (as shown in FIG. 7A).

The relativity comparison unit 410 is configured to compare the similarity among the users 1 according to parameters setting (such as setting of ranking list, ranking item, age, gender, or address), the ranking items and the ranking list of the ranking item unit 402, and the personal ingredient diagram generated by the personal ingredient diagram generation unit 409. Then the relativity comparison unit 410 generates the similarity and correlation for the interaction unit 405 to enhance interaction among users.

For example, when a parameters setting of a female, living in Taipei city, age of 20-25, and the ranking list comprises CHANEL, Sheena Ringo, 500 days of summer, iphone3G, T.G.I Fridays, then the relativity comparison unit 410 is able to locate the user 1 matching the aforementioned parameters setting. Then the interaction unit 405 is utilized to send a card to the located user 1 to make the located user 1 know “how matching they are” (i.e. the relativity degree of the two persons' ranking lists.). Then the connecting unit 400 is utilized to connect the personal page of the located user 1 and enhance friend making.

The database 5 is configured to store data of the friend system 40 for operating the operation processor 42, and comprises:

a member profile database 51, being configured to store the type of data of profile data file 511 for the user profile edit unit 403 and corresponding image/multimedia data file 512;

a ranking list database 52, being configured to store the type of data of ranking list item file 521 of the ranking item unit 402 and corresponding image/multimedia data file 522.

The friend system 40 is able to connect to an external system 6 via the ranking items of the ranking item unit 402. For example, if the ranking item relates to a certain sports brand name (such as NIKE), the ranking item is able to provide a hyperlink linking to the particular page of the business system.

The external system 6 can be a social website system (such as the FACEBOOK) other than the friend system 40 of the present invention, and the members of the external system 6 are able to access the friend system 40 of the present invention and utilize the functions thereof.

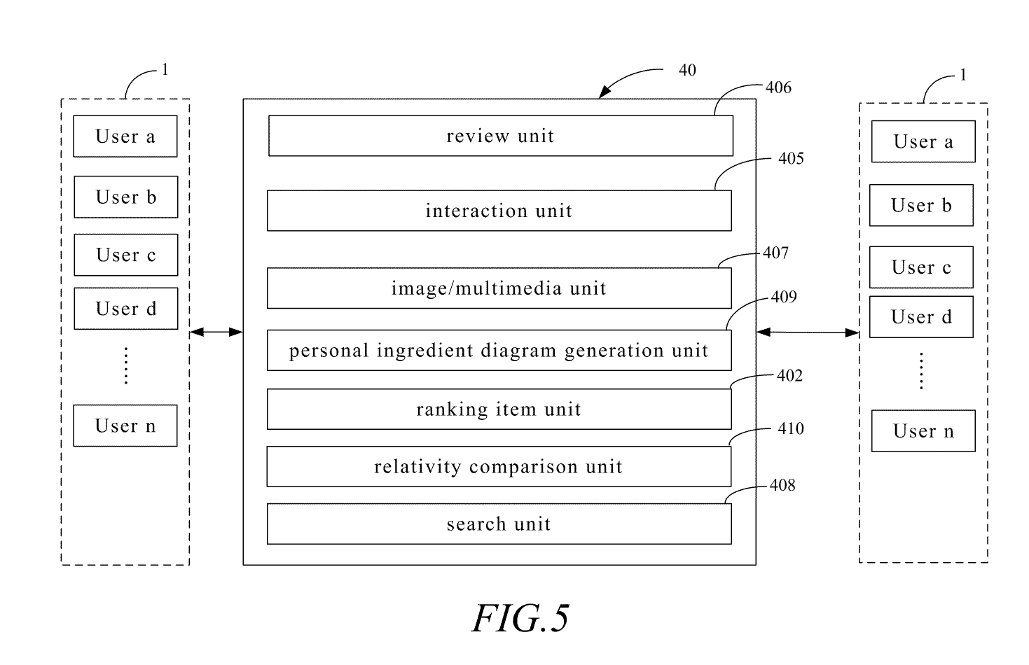

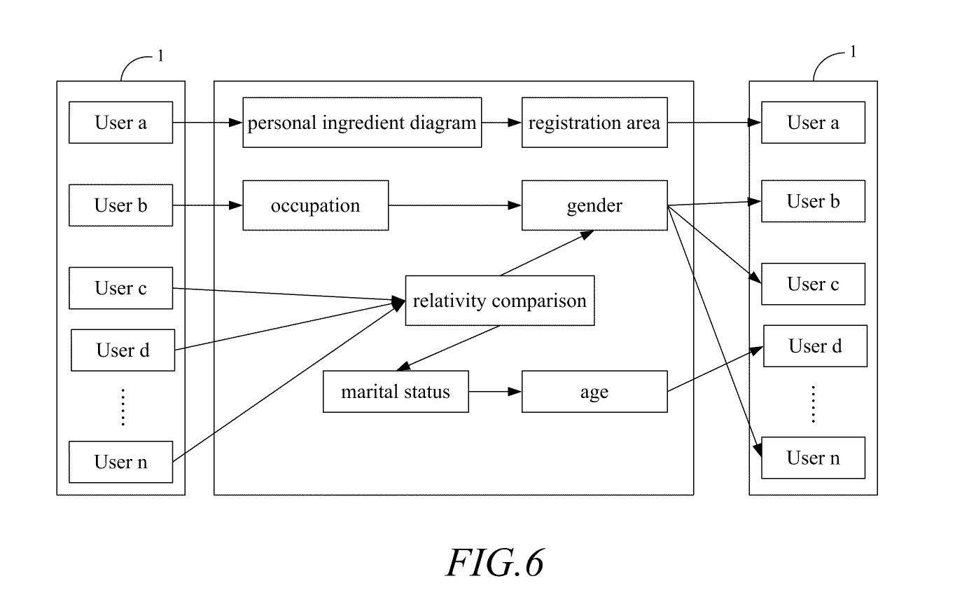

FIGS. 5, 6 show an demonstration chart of the friend system based on interest ranking of the present invention.

The user 1 uses the friend system 40 to establish the ranking items of the ranking item unit 402. The ranking item unit 402 transversely connects and vertically integrates the review unit 406, the interaction unit 405, the image/multimedia unit 407, the personal ingredient diagram generation unit 409, the relativity comparison unit 410 and the search unit 408, thus the interaction among users is enhanced. For example, the user 1 can use the personal ingredient diagram generated by the personal ingredient diagram generation unit 409, associated with the registration area information, to match other users 1. Also, the user 1 can use parameters setup relativity of the relativity comparison unit 410, associated with gender, marital status, or age, to match other users 1. After matching, the user 1 can use the interaction unit 405 to mutually join the matched user 1 as friend, mutually engage, or join as the user's cheer squad. The user 1 can use the review unit 406 to review or response the ranking items of the matched user 1.

FIG. 7 A shows a diagram of personal interface 411 of the friend system based on interest ranking of the present invention, which mainly shows the user's personal page, comprising:

a search unit 408, being configured to do keyword search among the ranking lists or the ranking items;

a movie ranking list and the ranking items thereof, based on a ranking item unit 402, in which each ranking list is adapted to generate the ingredient diagram by the personal ingredient diagram generation unit 409.

FIG. 7B shows a diagram of ranking list interface 412 of the friend system based on interest ranking of the present invention, which mainly shows the ranking list, comprising:

a ranking item unit 402, further comprising the name of the ranking list, reviews or image/multimedia of the ranking item unit and the ranking items.

FIG. 7C shows a diagram of ranking list calculation interface 413 of the friend system based on interest ranking of the present invention, which mainly shows the ranking list calculation, comprising the hot-popular ranking list of all system or the hot-popular ranking items.

FIGS. 7D, 7E show diagrams of the friend system based on interest ranking of the present invention, comprising a interaction unit 405, a review unit 406, and a image/multimedia unit 407. The interaction unit 407 is capable of functions of joining the cheer squad, joining as friend or joining the user's cheer squad.

FIGS. 7D, 7E show diagrams of the friend system based on interest ranking of the present invention, in which the friend system is able to connect to external systems and is able to login a particular page of the business system, or the members of the external system are able to access the friend system of the present invention and utilize the functions thereof.

FIG. 7G shows a relativity comparison unit of the friend system based on interest ranking of the present invention.

For example, when a parameters setting of a female, living in Taipei city, age of 20-25, and the ranking list comprises CHANEL, Sheena Ringo, 500 days of summer, iphone3G, T.G.I Fridays, then the relativity comparison unit is able to locate the user matching the aforementioned parameters setting. Then the interaction unit is utilized to send a card to the located user to make the located user know “how matching they are” (i.e. the relativity degree of the two persons' ranking lists.). Then the connecting unit is utilized to connect the personal page of the located user and enhance friend making

The friend system based on interest ranking of the present invention, comparing with other conventional technologies, is advantaged as follows.

1. The present invention transversely connects and vertically integrates kinds of interface and applications of each unit, thus the users are able to interactively make friend by the units.

2. The present invention generates personal ingredient diagram according to the ranking list that every user join therein, thus the user is able to expressly know the personal characters of the other user for making friend.

3. The present invention is configured to utilize the interaction unit to make the other users interact mutually for making friend.

4. The present invention is configured to utilize the review unit to make the other users interact mutually for making friend.

5. The present invention is configured to upload many image/multimedia data via the image/multimedia unit to enrich the pages.

6. The present invention is configured to provide a relativity comparison unit for calculating the relativity among users and then derive the similarity in response to the ranking list of the user itself for making friend.

The aforementioned descriptions are solely for explaining the embodiments of the present invention and are not intended to limit the scope of the present invention. Any equivalent practice of modification within the spirit of the present invention should be treated as being within the scope of patent of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A friend system based on interest ranking, operating in a server, in which an operation processor is configured to access data of a database, and the operation result and kinds of applications are transmitted via an input/output interface module and internet to users, or the friend system is configured to be connected to an external system via the internet, the friend system comprising:
a ranking item unit, comprising a ranking list of many ranking items, in which the user is able to add or join the ranking list and edit each ranking item by a ranking edit unit;
a reviewing unit, being configured to review each ranking item of the ranking item unit or the ranking list, and to response to the reviews thereof;
a personal ingredient diagram generation unit, being configured to generate a personal ingredient diagram based on the ranking lists of the ranking item unit that the user participating in;
a relativity comparison unit, being configured to compare the similarity among the users according to parameters setting, the ranking items and the ranking list of the ranking item unit, and the personal ingredient diagram; and
a connecting unit, being configured to connect the aforementioned units together and to integrate the ranking items and the ranking list of the ranking item unit.

2. The friend system based on interest ranking as claimed in claim 1, further comprising a user profile edit unit, in which the user inputs personal profile via the user profile edit unit and uploads image/multimedia data via an image/multimedia unit.

3. The friend system based on interest ranking as claimed in claim 1, further comprising an interaction unit, being configured to provide functions of adding friend, joining cheer squad, subscribing, engaging, subscribing RSS or broadcasting among users.

4. The friend system based on interest ranking as claimed in claim 1, further comprising a searching unit, being configured to search the ranking items, the ranking list and the user profiles of the ranking item unit by keywords.

5. The friend system based on interest ranking as claimed in claim 1, further comprising an image/multimedia unit, in which the image/multimedia unit is configured to provide image/multimedia data related to the ranking items and the ranking list of the ranking item unit, or the user can upload personal profile via the image/multimedia unit.

6. The friend system based on interest ranking as claimed in claim 1, wherein the input/output interface module is configured to utilize an interface setup unit to present a personal interface, a ranking list interface, or a ranking calculation interface in front of the user according to the user's selection, and a connection unit is configured to connect each interface.

7. The friend system based on interest ranking as claimed in claim 6, wherein the personal interface comprises the user's friend list, the ranking list, or the personal profile.

8. The friend system based on interest ranking as claimed in claim 6, wherein the ranking list interface further comprises the user's friend list, the ranking list, or the personal profile.

9. The friend system based on interest ranking as claimed in claim 6, wherein the ranking calculation interface further comprises an integrated hot-popular ranking list or an integrated hot-popular ranking item list.

10. The friend system based on interest ranking as claimed in claim 1, wherein the database further comprises a member profile database and a ranking list database having data types of a basic profile file, a ranking list file, and an image/multimedia file.

11. The friend system based on interest ranking as claimed in claim 1, wherein the external system can be a business system, and the ranking item of the ranking item unit is configured to be connected to the business system and is able to login a particular page of the business system.

12. The friend system based on interest ranking as claimed in claim 1, wherein the external system can be a social website system other than the friend system of the present invention, and the members of the external system are able to access the friend system of the present invention and utilize the functions thereof.

13. A computer readable record media with stored program, when a computer installs and runs the program, the computer is able to operate as the system claimed in claim 1.
